(19) United States
(12) Patent Application Publication
(10) Pub. No.: US 2025/0086464 A1
(43) Pub. Date: Mar. 13, 2025

(54) EXECUTING PLAYBOOKS BASED ON CLUSTER DRIFT

(71) Applicant: SuccessKPI, Inc., Centreville, VA (US)

(72) Inventors: Pawel KRAWCZYK, Warszawa (PL); Vivek PATEL, South Riding, VA (US); Keith STEWARD, Boston, MA (US); Suresh PARISHI, Charlotte, NC (US); Amitkumar PANDYA, Pleasanton, CA (US); Stephen LIPPENS, Ashburn, VA (US); Michael DAVIES, London (GB); Praphul KUMAR, Aldie, VA (US); David J. RENNYSON, Centreville, VA (US); Piyush PATEL, South Riding, VA (US); Dimple SINHA, Aldie, VA (US); Madelin RENNYSON, Centreville, VA (US)

(73) Assignee: SuccessKPI, Inc., Centreville, VA (US)

(21) Appl. No.: 18/465,125

(22) Filed: Sep. 11, 2023

(51) Int. Cl. G06N 3/088

(52) U.S. Cl. CPC G06N 3/088

(57) ABSTRACT

Methods and systems are disclosed herein for using machine learning models to predict proper resource levels and performance levels of those resources. One mechanism for predicting proper resource levels and performance levels of those resources may involve a use of a machine learning model that is enabled to receive user data as input and output a predication for one or more actions for each user. The users may be clustered based on the user action predicted by the machine learning model and one or more action sequences may be executed against each action cluster.

### BACKGROUND

In recent years many enterprises have been attempting to predict proper resource levels and performance levels of those resources. However, it has been difficult to make those predictions in view of different variables required to make those predictions. Recently, use of machine learning technologies has been growing exponentially. Machine learning models are now used in many technology areas including computer vision, network monitoring, autonomous driving, and others. Generally, machine learning models are trained using, for example, a training dataset that enables them to make predictions based on that training.

### SUMMARY

Accordingly, methods and systems are disclosed herein for using machine learning models to predict proper resource levels and performance levels of those resources. One mechanism for predicting proper resource levels and performance levels of those resources may involve a use of a machine learning model that is enabled to receive user data as input and output a predication for one or more actions for each user. In particular, this mechanism may use a tracking system for these predictions.

In some embodiments, the tracking system may receive user data for a plurality of users. The user data may include a plurality of fields. The user data may be user profile data, user activity data, and/or any other type of user data. In some embodiments, each type of user data may be retrieved from a different data source (e.g., from a different database or database table, etc.). For example, user profile data may be received from a first data source and user activity data may be received from a second data source.

The tracking system may then transform the user data into a user dataset that includes a plurality of features. For example, the user profile data and the user activity data may include some overlapping fields. Thus, the tracking system may collapse those fields into a single field. In another example, the user profile data and the user activity data may have non-overlapping users. Accordingly, the tracking system may remove the non-overlapping users from the user dataset. In some embodiments, the tracking system may leave the non-overlapping users in the user dataset and fill in the missing data or zero out the missing fields.

The tracking system may then generate a plurality of vectors for the plurality of users within the user dataset. For example, the database may include a plurality of features (e.g., columns) and a plurality of entries (e.g., rows). Each row may represent data for a particular user. Accordingly, the tracking system may generate a vector for each user based on the feature values for the user. The tracking system may use various methods to vectorize each entry (e.g., Word2Vec, Doc2Vec, etc.).

The tracking system may then input, into a machine learning model, the plurality of vectors to obtain a plurality of actions associated with the plurality of users. For example, the machine learning model may take, as input, a single vector and output a probability of a single action. In some embodiments, the machine learning model may take, as input, a plurality of vectors (e.g., vectors for the whole dataset) and output one or more actions for each vector with a corresponding probability for that action. The tracking system may store the output in a data structure.

The machine learning model may be trained based on training data that may include labels for actions associated with users. For example, the tracking system may receive training data that includes user data (e.g., user profile data and user activity data) and may retrieve actions that have been taken in association with those users whose user data is within the training data. The tracking system may then generate a training dataset with labels representing real outcome to train the machine learning model for predicting outcomes. For example, the machine learning model may output an action that would ask a user to attend a training class and/or a type of a training class.

The tracking system may generate a plurality of action clusters for the plurality of actions. Each action cluster of the plurality of action clusters may include a set of users with a corresponding predicted action. For example, the output of the machine learning model may include an action for each input vector (e.g., for each user). In some embodiments, some users may not have a predicted action (e.g., because the probability is too low). Each of the actions may be a categorical feature. Thus, the tracking system may group the users based on the predicted action. For example, if a particular action may have been predicted for one hundred users, accordingly, the tracking system may generate a cluster of users associated with that action. The tracking system may perform this operation for other actions and cluster users based on each action. For example, if the action is to take a training class or a type of a training class, the tracking system may generate an action cluster for attending a training class.

In some embodiments, there may not be enough users within the action cluster for executing the operations. Thus, the tracking system may remove that action cluster from the list to be processed. In particular, the tracking system may select a first action cluster of the plurality of action clusters and determine a number of users within the first action cluster. Based on the number of users within the first action cluster not meeting a threshold, the tracking system may remove the first action cluster from the plurality of action clusters.

When the users are clustered by actions, the tracking system may perform operations associated with each cluster. For example, the tracking system may, based on a corresponding action of the plurality of actions, identify, for each action cluster in the plurality of action clusters, a corresponding action sequence to execute for users associated with a corresponding action cluster. In some embodiments the action sequence may be a playbook, which will be described later in this disclosure. For example, an action sequence for attending a training class may involve sending scheduling notifications to users and scheduling the users for one of many training classes based on user responses.

The tracking system may then execute the corresponding action sequence for each action cluster of the plurality of action clusters. For example, the tracking system may execute a particular playbook based on the action. However, a playbook may need data associated with the users within the action cluster that is causing the playbook to be executed. Thus, the tracking system may select a first action cluster of the plurality of action clusters, determine one or more characteristics common to a first set of users within the first action cluster, and pass one or more indicators of the one or more characteristics to a first action sequence being executed for the first action cluster. To continue with the example above, different users may need to attend different training classes based on various characteristics. Thus, the tracking system may determine those characteristics based on user data.

Various other aspects, features and advantages of the system will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 illustrates a system for using machine learning models to predict proper resource levels and performance, in accordance with one or more embodiments of this disclosure.

FIG. 2 illustrates an excerpt from a user dataset, in accordance with one or more embodiments of this disclosure.

FIG. 3 illustrates an excerpt of a data structure storing vectors, in accordance with one or more embodiments of this disclosure.

FIG. 4 illustrates an exemplary machine learning model, in accordance with some embodiments of this disclosure.

FIG. 5 illustrates an excerpt from a data structure storing clustering information, in accordance with one or more embodiments of this disclosure.

FIG. 6 shows an example computing system that may be used, in accordance with one or more embodiments of this disclosure.

FIG. 7 is a flowchart of operations for using machine learning models to predict proper resource levels and performance, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

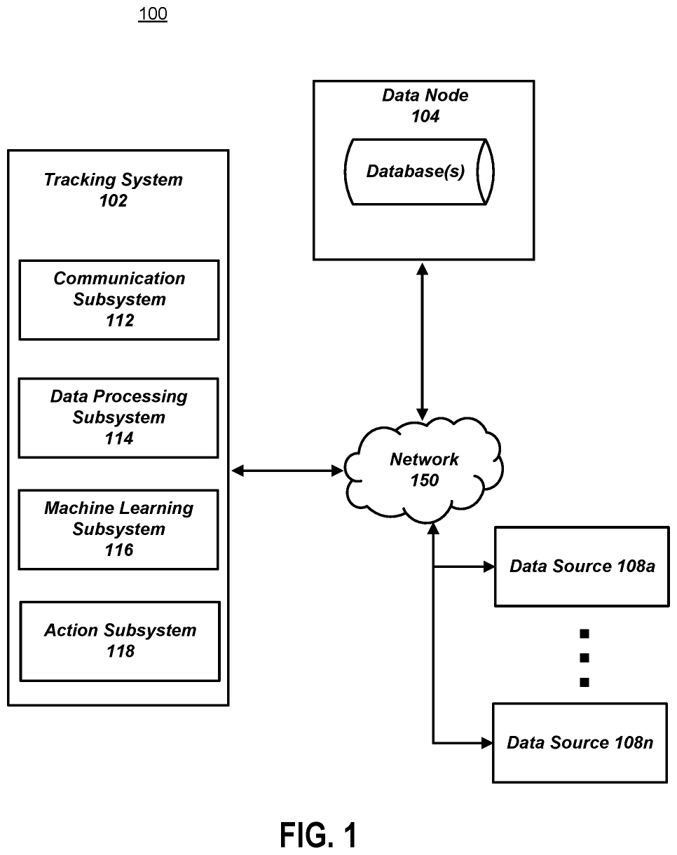

FIG. 1 illustrates environment 100, which includes a system for using machine learning models to predict proper resource levels and performance levels of those resources. Environment 100 includes tracking system 102, data node 104, and data sources 108a-108n. Tracking system 102 may execute instructions for using machine learning models to predict proper resource levels and performance levels of those resources, and may include software, hardware, or a combination of the two. For example, tracking system 102 may be a physical server or a virtual server that is running on a physical computer system.

Data node 104 may store various data, including various machine learning models, training and other datasets, and other data required by the tracking system. In some embodiments, data node 104 may also be used to train machine learning models. Data node 104 may include software, hardware, or a combination of the two. For example, data node 104 may be a physical server or a virtual server that is running on a physical computer system. Network 150 may be a local area network, a wide area network (e.g., the Internet), or a combination of the two. Data sources 108a-108n may be server devices (e.g., database servers) or other types of devices (e.g., desktop computers, laptops, electronic tablets and/or other computing devices used by end users). Data sources 108a-108n may store various data needed for generating dataset (e.g., training dataset or execute datasets).

Tracking system 102 may include communication subsystem 112. Communication subsystem 112 may include software components, hardware components, or a combination of both. For example, communication subsystem 112 may include a network card (e.g., a wireless network card and/or a wired network card) that is coupled with software to drive the card. Tracking system 102 may also include data processing subsystem 114. Data processing subsystem 114 may include software components, hardware components, or a combination of both. Data processing subsystem 114 may perform data collection operations, dataset creation operations and/or other suitable operations.

In addition, tracking system 102 may include machine learning subsystem 116. Machine learning subsystem 116 may include software components, hardware components, or a combination of both. Machine learning subsystem 116 may store one or more machine learning models, interact with those models (e.g., via an API), update those models when necessary, and/or train those models. Tracking system 102 may also include action subsystem 118. Action subsystem 118 may include software components, hardware components, or a combination of both. In some embodiments, action subsystem 118 may perform actions (e.g., execute action sequences and/or playbooks) identified by machine learning subsystem 116.

One usage of tracking system 102 may be in the context of an entity that employs people. Thus, the users discussed below may be employees of a business or a corporation. In particular, the tracking system enables evaluating and predicting employee performance (e.g., contact center employees), and taking automated actions to alert and enable various departments on churn risks, hiring plans, training opportunities etc. The tracking system may leverage multiple sources of information (e.g., multiple sources of user/employee data) as it relates to the employee experience to wholistically evaluate employee performance and predict certain outcomes based on human feedback, machine feedback and historical trends & patterns.

The first step in evaluating employee performance is understanding the employee activities and gathering context on these activities. Accordingly, tracking system 102 may receive, using communication subsystem 112, user data (e.g., user profile data and user activity data) for a plurality of users. The user profile data may include a first plurality of features, and the user activity data may include a second plurality of features. In some embodiments, the user profile data and the user activity data may be received from different data sources (e.g., two or more of data sources 108a-108n). The data sources may be different databases.

The user profile data may include data elements such as when each employee was hired, where the employee was previously employed, the position the employee fills, and the skills and resources the employee brings to the business, among others. User activity data may include information on the employees' day-today functions (e.g., how many hours the employee works per day/week/month), adherence to schedule, quality evaluation scores, trends and other activity data. In addition, the user activity data may include employee review data, performance data, comments from customers, and/or other data. Accordingly, these categories of information may encompass the employee experience as it relates to performance based on company standards. Communication subsystem 112 may pass the user data to data processing subsystem 114.

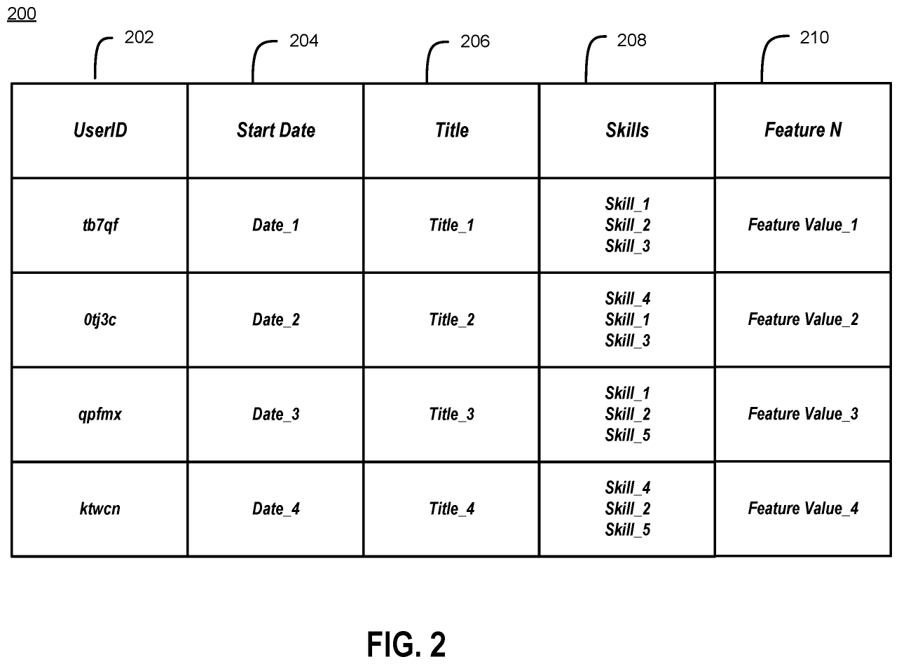

When the user data is received, the tracking system may bring that data together into a single data source. For example, data processing subsystem 114 may transform the user data into a user dataset that includes a plurality of features. Each feature may be a column while each row may be an entry. FIG. 2 illustrates an excerpt from a user dataset 200. User dataset 200 is illustrated with a number of fields. Each of those fields may be a feature of the dataset, while each value within each field may be a feature value. The fields of FIG. 2 are just example fields. Other fields, and other combinations of fields may be used with user dataset 200. Field 202 may store a user identifier which may be an employee identifier and may be unique for every employee. Field 204 may store an employee start data, field 206 may store an employee's title (e.g., position), field 208 may store a list of skills associated with an employee and field 210 may store another feature for an employee.

Tracking system 102 may add other data in the dataset. For example, tracking system 102 may ingest other data elements and datasets from different sources such as a Human Resources Management System (HRMS) or Customer Relationship Management database (CRM). The data may be combined with Contact Center as a Service (CCaaS) data to create a singular view of the employee experience. For example, tracking system 102 may perform various transformations on the data to get the data into the correct format for processing. In some embodiments, data processing subsystem 114 may transform the first plurality of features and the second plurality of features into a user dataset. For example, some fields from different data sources may overlap. Thus, data processing subsystem 114 may deduplicate those fields when generating the user dataset.

When the data is consolidated into, for example, a data warehouse that may be hosted on data node 104, artificial intelligence algorithms (e.g., one or more machine learning models) may be executed against the data to predict outcomes related to employee experience such as performance, tenure, training opportunities, churn, and overall job satisfaction. Based on patterns recognized by the machine learning model, predictive analysis may be performed on different aspects of the employee experience to provide the employer with insight needed to effectively manage large numbers of employees. Accordingly, tracking system 102 may, via machine learning subsystem 114, generate a plurality of vectors for the plurality of users within the user dataset. The tracking system may use various methods to vectorize each entry (e.g., Word2Vec. Doc2Vec, etc.). For example, machine learning subsystem 116 may iterate through each entry (e.g., each row) within the dataset and retrieve the feature values for each entry. Thus, machine learning subsystem 116 may generate a vector for each entry.

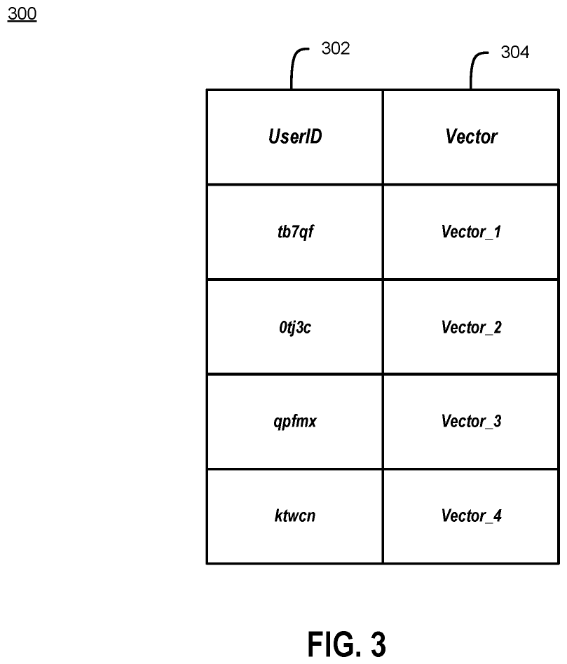

FIG. 3 illustrates an excerpt of a data structure 300 for storing vectors. Data structure 300 may include a field 302 storing a user identifier and field 304 storing a corresponding vector. In some embodiments, data structure 300 may be in a format that may be input into a machine learning model. Thus, machine learning subsystem 116 may input, into a machine learning model, the plurality of vectors to obtain a plurality of actions associated with the plurality of users.

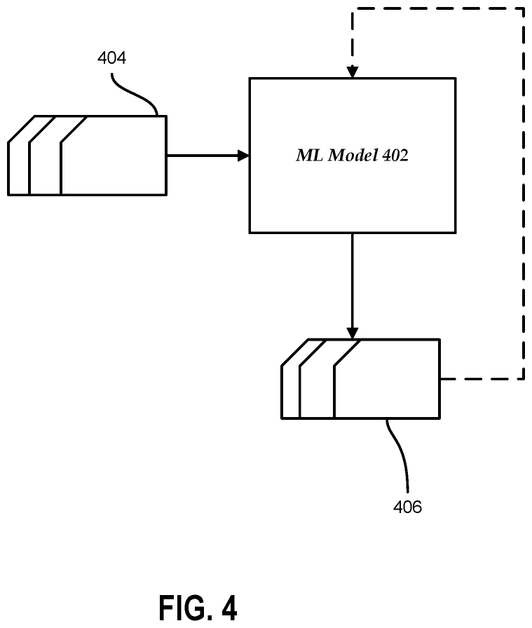

FIG. 4 illustrates an exemplary machine learning model that may be used to identify actions for users (e.g., employees). Machine learning model 402 may take input 404 (e.g., a vectorized entry representing an employee) and may generate output parameters 406, which may be one or more characterizations.

The output parameters 406 may be fed back to the machine learning model as input to train the machine learning model (e.g., alone or in conjunction with user indications of the accuracy of outputs, labels associated with the inputs, or with other reference feedback information). The machine learning model may update its configurations (e.g., weights, biases, or other parameters) based on the assessment of its prediction (e.g., of an information source), and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function which combines the values of all of its inputs together. Each connection (or the neural unit itself) may have a threshold function that a signal must surpass before it propagates to other neural units. The machine learning model may be self-learning and/or trained rather than explicitly programmed and may perform significantly better in certain areas of problem solving, as compared to computer programs that do not use machine learning. During training, an output layer of the machine learning model may correspond to a classification of the machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector.

The machine learning model may be structured as a factorization machine model. The machine learning model may be a non-linear model and/or supervised learning model that can perform classification and/or regression. For example, the machine learning model may be a general-purpose, supervised learning algorithm that the system uses for both classification and regression tasks. Alternatively, the machine learning model may include a Bayesian model configured to perform variational inference on the graph and/or vector.

The machine learning model may be trained using training data. In particular, machine learning subsystem 116 may retrieve user profile training data that includes a first plurality of training features and user activity training data that includes a second plurality of training features. The user profile training data and the user activity training data may be associated with a training set of users. For example, tracking system 102 may have access to a dataset of all employees (past and present) for a particular enterprise. Machine learning subsystem 116 may identify those employees that have resigned in the past or those that may have been fired. Based on that data, the machine learning subsystem may generate a label for each past employee with an action. The action may be that a person generally separated from the enterprise. However, in some embodiments, the label may indicate that a person was fired or had quit on their own.

In some embodiments, machine learning subsystem 116 may retrieve action data that includes a plurality of training actions associated with the training set of users. For example, instead of generating a label, machine learning subsystem 116 may have access to those labels as a portion of the dataset. Such label may indicate a termination date or the last date that an employee was employed at the enterprise. In some embodiments, the retrieval process may be used for actions where an employee was assigned to attend a training course based on their skillset and performance. The label may also indicate the type of course that was assigned.

Machine learning subsystem 116 may then transform, into a training dataset, (1) the user profile training data, (2) the user activity training data, and (3) the action data. The training dataset may include (1) a subset of the first plurality of training features and the second plurality of training features and (2) the action data representing a corresponding label for each user identifying an observed action for each user. For example, machine learning subsystem 116 may identify a particular user (e.g., based on a user identifier) within multiple datasets and combine the appropriate fields into a training dataset. Machine learning subsystem 116 may also deduplicate fields that overlap within different datasets.

When the training dataset has been generated, machine learning subsystem 116 may transform the training dataset into a plurality of training vectors. Each vector of the plurality of vectors may represent a user within a set of training users and each vector may be associated with the corresponding label. Machine learning subsystem 116 may use various methods to vectorize each entry within the training dataset (e.g., Word2Vec, Doc2Vec, etc.). For example, machine learning subsystem 116 may iterate through each entry (e.g., each row) within the training dataset and retrieve the feature values for each entry. Thus, machine learning subsystem 116 may generate a vector for each entry.

Machine learning subsystem 116 may then train the machine learning model, using the plurality of training vectors to predict the corresponding action for each user in the set of training users. For example, machine learning subsystem 116 may input the plurality of vectors and the corresponding labels into a training routine of the machine learning model. In some embodiments, machine learning subsystem 116 may keep updating the machine learning model when new training data is available. In some embodiments, the machine learning model may update its configurations (e.g., weights, biases, or other parameters) based on the assessment of its prediction (e.g., of an information source), and reference feedback information (e.g., user indication of accuracy, reference labels, or other information). Connection weights may be adjusted, for example, if the machine learning model is a neural network, to reconcile differences between the neural network's prediction and the reference feedback.

Turning back to the use of the machine learning model, machine learning subsystem 116 may store the predictions of the machine learning model in a data structure and may pass an indication to action subsystem 118 that predictions have been generated. Action subsystem 118 may generate a plurality of action clusters for the plurality of actions. Each action cluster of the plurality of action clusters may include a set of users with a corresponding predicted action. For example, action subsystem 118 may iterate through each prediction by the machine learning model (e.g., for each employee) and group the users based on each prediction. This process may result in multiple groups of users. Action subsystem 118 may store the results in a data structure.

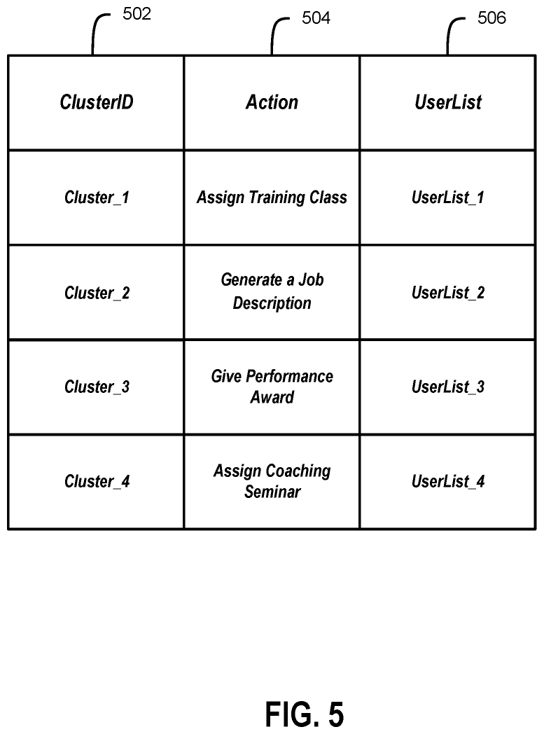

FIG. 5 illustrates an excerpt from a data structure 500 for storing clustering information. In particular, field 502 stores a cluster identifier, which may be any type of value (e.g., an alphanumeric value, or another suitable value). Field 504 stores an action identifier for each cluster. The action identifier may be one of “assign training class,” “generate a job description,” “give performance award,” or “assign coaching seminar.” Other sets of actions may be used as well in field 504.

Based on this process, employers, in addition to identifying gaps in training or coaching opportunities, may plan their hiring based on traffic prediction, staffing needs and churn prediction. Within the contact center industry, there is a primary focus on the agent, but oftentimes, their supervisors and managers are lacking the tools they require to keep up with industry trends. Empowering the individuals whose job is to manage, coach, and retain the agents will allow for efficient and more effective top-down leadership. Accordingly, based on a corresponding action of the plurality of actions, action subsystem 118 may identify, for each action cluster in the plurality of action clusters a corresponding action sequence to execute for users associated with a corresponding action cluster. In some embodiments, each action sequence may be a playbook. Playbooks are discussed in application Ser. No. 17/535,323, filed on Nov. 24, 2021, which is hereby incorporated by reference in its entirety.

In some embodiments, a playbook may include one or more actions to be performed with respect to the users within the cluster. For example, if an action associated with a cluster predicts that the employees within the cluster will leave, the playbook may include an action sequence to, for example, notify one or more managers within an enterprise and generate a job description for the employees within the cluster. In particular, action subsystem 118 may select a first action cluster of the plurality of action clusters. The action for the first action cluster may indicate that there is a probability the one or more employees may resign from their position.

Action subsystem 118 may then determine one or more characteristics common to a first set of users within the first action cluster. For example, the first cluster of users may have an associated action that predicts that there is a probability (e.g., a probability above a certain threshold) that each user within the cluster is going to separate from the enterprise (e.g., be fired or quit). In response, action subsystem 118 may compare characteristics of those users. For example, the majority of those users may be call center operators that accept customer calls for product support. Accordingly, those users may have some identical characteristics (e.g., job title, experience, etc.). Action subsystem 118 may identify those common characteristics.

When those common characteristics are identified, action subsystem 118 may pass one or more indicators of the one or more characteristics to a first action sequence being executed for the first action cluster. For example, the first action sequence (e.g., a first playbook) may require generating a job description based on the users predicted to separate from the enterprise. In addition, the first action sequence may require notifying one or more people (e.g., via electronic messages) regarding the predicted separation. To generate a job description, action subsystem 118 may require a set of skills to include with the job description. Accordingly, action subsystem 118 may generate those skills from the user data associated with users within the first cluster.

Furthermore, action subsystem 118 may create a job description (e.g., via a large language model) based on the skills common to the users. In some embodiments, action subsystem 118 may use one or more characteristics that are not common to the users within the cluster as optional skills within the job description. In particular, action subsystem 118 may generate a textual file for publication. The textual file may include the one or more characteristics marked as required and other characteristics of users within the first action cluster marked as optional.

When action subsystem 118 identifies the action sequence corresponding to the action, action subsystem 118 may execute the corresponding action sequence for each action cluster of the plurality of action clusters. For example, action subsystem 118 may generate a job description or a list of skills for a particular cluster of users and transmit (e.g., via an electronic message) that information to an appropriate person. In another example, action subsystem 118 may perform one or more operations to schedule a training class for users within an action cluster (e.g., when an action associated with an employee is “assign a training class”). Those operations may include retrieving users' (e.g., employees') electronic addresses and transmitting calendar invites to the users within the action cluster. In response to receiving a response, action subsystem 118 may transmit another electronic message to the users who accepted the invite, such that the electronic message confirms class scheduling.

In some embodiments, action subsystem 118 may refrain from executing an action sequence for a cluster or otherwise remove the cluster from a list of action clusters to be processed under some circumstances (e.g., when there are not enough users in a cluster). In particular, action subsystem 118 may select a first action cluster of the plurality of action clusters. Action subsystem 118 may iterate through each cluster and select each cluster in turn. Action subsystem 118 may determine a number of users within the first action cluster. For example, action subsystem 118 may access a data structure such as data structure 500 and retrieve a user list (e.g., user list 506) to determine the number of users (e.g., the number of employees) within the action cluster. Based on the number of users within the first action cluster not meeting a threshold, action subsystem 118 may remove the first action cluster from the plurality of action clusters. For example, an action cluster may include an action of “generate a job description.” based on the employees within the action cluster that are predicted to leave. However, the action cluster may have a small number of users (e.g., two or three). Thus, action subsystem 118 may not process the action corresponding to the action cluster.

In some embodiments, action subsystem 118 may refrain from processing an action cluster when the users (e.g., employees) within the cluster are not heterogeneous enough. In particular, action subsystem 118 may select a first action cluster of the plurality of action clusters. Action subsystem 118 may then iterate through each user within the first action cluster and determine that a number of common characteristics for a first set of users within the first action cluster does not meet a threshold. For example, the action associated with the action cluster may indicate that the users (e.g., employees) within the action cluster are predicted to separate from the enterprise. Thus, action subsystem 118 may then determine some common characteristics for the users. For example, action subsystem 118 may determine the job titles of the users and whether those job titles are different. Action subsystem 118 may also identify a department associated with the users and determine whether the majority or many users are within the department. In another example, action subsystem 118 may identify skills that are shared by the users (e.g., employees) associated with the action cluster being processed.

Based on determining that the number of common characteristics for the set of users within the first action cluster does not meet the threshold, action subsystem 118 may remove the first action cluster from the plurality of action clusters. For example, the threshold may be based on a number of users (e.g., employees) that are similar. Action subsystem 118 may determine users that are similar based on one or more fields within the user data. For example, two users may be similar if they have the same job title and/or department. In another example, two users may be similar if they have three or more job skills that are the same. Other ways of determining user similarity may be used. Accordingly, if the number of users who are similar does not reach/meet the threshold, action subsystem 118 may not process the cluster. For example, it may not be necessary to generate a job description if only two users within the action cluster who are similar (e.g., have the same job title) were predicted to separate from the company. However, the users within the action cluster may further be clustered based on similarity. For example, an action cluster may include 50 employees. Out of the 50 employees, 30 may be similar (e.g., have the same job title) while the other 20 may have 10 different job titles. Accordingly, action subsystem 116 may generate a job description based on the characteristics of those 30 employees.

As mentioned above, in some embodiments, action subsystem 118 may determine that a playbook should be executed for an action cluster that requires scheduling a training class and may execute that playbook. In particular, action subsystem 118 may select a second action cluster of the plurality of action clusters. For example, action subsystem 118 may iterate through each action cluster and execute action sequences (e.g., playbooks) as described above. Action subsystem 118 may determine that a type of action associated with the second action cluster indicates executing a second action sequence (e.g., a second playbook) for each user within the second action cluster. In some embodiments, the second playbook may include one or more instructions to schedule a training class for each user. For example, action subsystem 118 may store a data structure with actions and corresponding action types. Based on the data structure, action subsystem 118 may identify the type of action for the second action cluster.

Furthermore, based on the type of action and the instructions in the action sequence (e.g., playbook), action subsystem 118 may retrieve a plurality of electronic addresses for the users within the second action cluster for scheduling the training class. For example, action subsystem 118 may access user data from a data source (e.g., as described above) and retrieve the electronic addresses associated with those users. Action subsystem 118 may then use those electronic addresses (e.g., email addresses) to transmit scheduling requests to employees for scheduling employee training.

Furthermore, action subsystem 118 may identify a type of training class needed for each user or a set of users. In particular, action subsystem 118 may receive, from the machine learning model, output data indicating one or more features that caused the machine learning model to add the users into the second action cluster. For example, the feature that caused the prediction may be that an employee is getting too many complaints from clients. In another example, the feature that caused the prediction may be that the employee is not following certain work procedures correctly. Accordingly, action subsystem 118 may determine, based on the one or more features, a training class type for the users in the second action cluster. For example, if the user is getting too many complaints from clients, action subsystem 118 may schedule a client service training class for the user.

### Computing Device Components

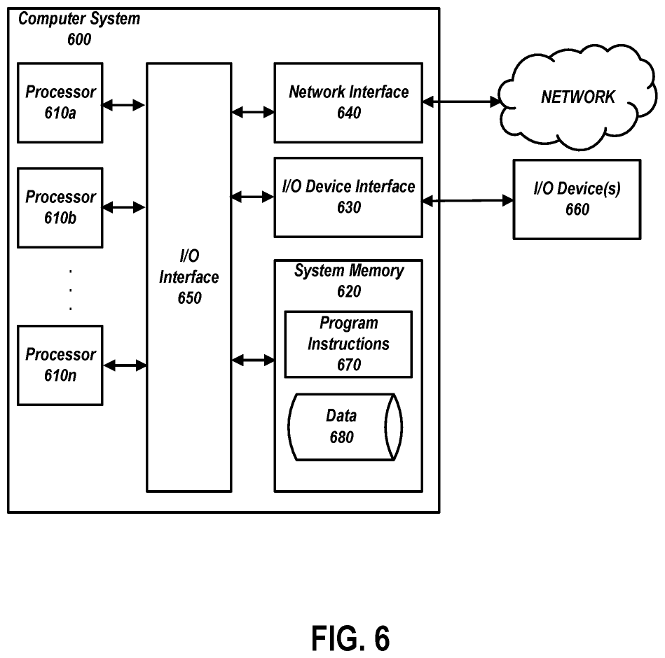

FIG. 6 shows an example computing system that may be used in accordance with some embodiments of this disclosure. Specifically, tracking system 102, data node 104 and/or data sources 108a-108n may use one or more of the components described below. In some instances, computing system 600 is referred to as a computer system. A person skilled in the art would understand that those terms may be used interchangeably. The components of FIG. 6 may be used to perform some or all operations and generate graphical user interfaces discussed in relation with FIGS. 1-5. Furthermore, various portions of the systems and methods described herein may include or be executed on one or more computer systems similar to computing system 600. Further, processes and modules described herein may be executed by one or more processing systems similar to those of computing system 600.

Computing system 600 may include one or more processors (e.g., processors 610a-610n) coupled to system memory 620, an input/output (I/O) device interface 630, and a network interface 640 via an I/O interface 650. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multiprocessor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network using network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions 670 may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600, or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Computing Operation Flow

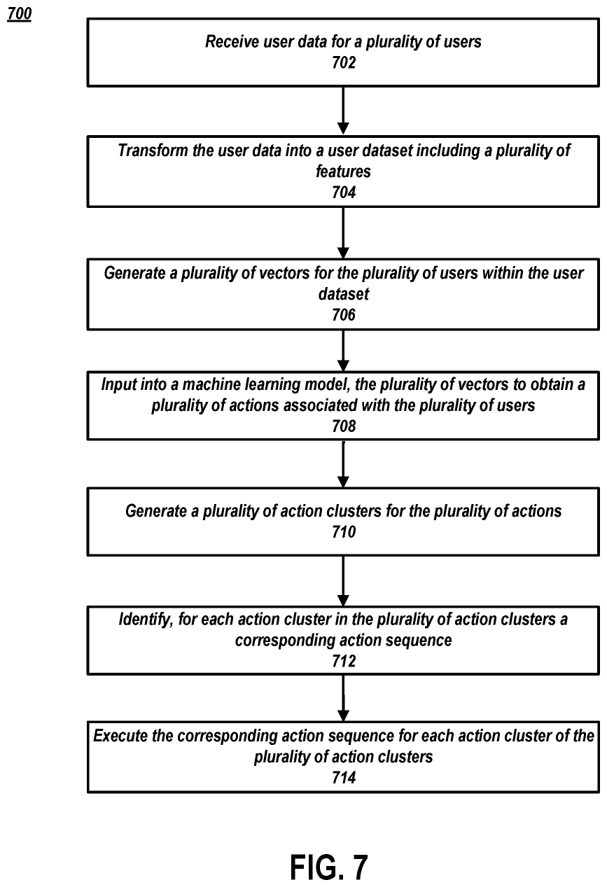

FIG. 7 illustrates a flowchart 700 of operations for a mechanism for identifying insights and themes in an electronic communication. The operations of FIG. 7 may use components described in relation to FIG. 6 and may be performed on machine learning models described in FIG. 4. At 702, tracking system 102 receives user data for a plurality of users. Tracking system 102 may receive the user data via network interface 640 from a network (e.g., network 150). At 704, tracking system 102 transforms the user data into a user dataset including a plurality of features. Tracking system 102 may perform the transform operation using one or more processors 610a-610n and may store the result in system memory 620.

At 706, tracking system 102 generates a plurality of vectors for the plurality of users within the user dataset. Tracking system 102 may use one or more processors 610a-610n to perform the generation. At 708, tracking system 102 inputs into a machine learning model the plurality of vectors to obtain a plurality of actions associated with the plurality of users. Tracking system 102 may use one or more processors 610a-610n to perform the input and may store the output in system memory 620. The machine learning model may be hosted on tracking system 102 or on data node 104. When the machine learning model is hosted on data node 104, tracking system 102 may use network interface 640 to perform the input operation over network 150.

At 710, tracking system 102 generates a plurality of action clusters for the plurality of actions. For example, tracking system 102 may perform this operation using processors 610a-610n and store the result in system memory 620. At 712, tracking system 102 identifies, for each action cluster in the plurality of action clusters a corresponding action sequence. For example, tracking system 102 may perform this operation using processors 610a-610n and store the result in system memory 620. At 714, tracking system 102 executes the corresponding action sequence for each action cluster of the plurality of action clusters. For example, tracking system 102 may perform this operation using processors 610a-610n and store the result in system memory 620.

The techniques for identifying insights and themes in an electronic communication will be better understood with reference to the following enumerated embodiments:

1. A method comprising: receiving user profile data and user activity data for a plurality of users, wherein the user profile data comprises a first plurality of features, and wherein the user activity data comprises a second plurality of features; transforming the first plurality of features and the second plurality of features into a user dataset; generating a plurality of vectors for the plurality of users within the user dataset; inputting, into a machine learning model, the plurality of vectors to obtain a plurality of actions associated with the plurality of users; generating a plurality of action clusters for the plurality of actions, wherein each action cluster of the plurality of action clusters comprises a set of users with a corresponding predicted action; based on a corresponding action of the plurality of actions, identifying, for each action cluster in the plurality of action clusters, a corresponding action sequence to execute for users associated with a corresponding action cluster; and executing the corresponding action sequence for each action cluster of the plurality of action clusters.

2. Any of the preceding embodiments, further comprising: retrieving user profile training data comprising a first plurality of training features and user activity training data comprising a second plurality of training features, wherein the user profile training data and the user activity training data is associated with a training set of users; retrieving action data comprising a plurality of training actions associated with the training set of users; transforming, into a training dataset, (1) the user profile training data. (2) the user activity training data, and (3) the action data, wherein the training dataset comprises (1) a subset of the first plurality of training features and the second plurality of training features and (2) the action data representing a corresponding label for each user identifying an observed action for each user; transforming the training dataset into a plurality of training vectors, wherein each vector of the plurality of vectors represents a user within a set of training users and each vector is associated with the corresponding label; and training the machine learning model, using the plurality of training vectors to predict the corresponding action for each user in the set of training users.

3. Any of the preceding embodiments, further comprising: selecting a first action cluster of the plurality of action clusters; determining a number of users within the first action cluster; and based on the number of users within the first action cluster not meeting a threshold, removing the first action cluster from the plurality of action clusters.

4. Any of the preceding embodiments, further comprising: selecting a first action cluster of the plurality of action clusters; determining one or more characteristics common to a first set of users within the first action cluster; and passing one or more indicators of the one or more characteristics to a first action sequence being executed for the first action cluster.

5. Any of the preceding embodiments, further comprising executing the first action sequence by generating a textual file for publication, wherein the textual file comprises the one or more characteristics marked as required and other characteristics of users within the first action cluster marked as optional.

6. Any of the preceding embodiments, further comprising: selecting a second action cluster of the plurality of action clusters; determining that a type of action associated with the second action cluster indicates executing a second playbook for each user within the second action cluster, wherein the second playbook comprises one or more instructions to schedule a training class for each user; and retrieving a plurality of electronic addresses for the users within the second action cluster for scheduling the training class.

7. Any of the preceding embodiments, further comprising: receiving, from the machine learning model, output data indicating one or more features that caused the machine learning model to add the users into the second action cluster; and determining, based on the one or more features, a training class type for the users in the second action cluster.

8. Any of the preceding embodiments, further comprising: selecting a first action cluster of the plurality of action clusters; determining that a number of common characteristics for a first set of users within the first action cluster does not meet a threshold; and based on determining that the number of common characteristics for the set of users within the first action cluster does not meet the threshold, removing the first action cluster from the plurality of action clusters.

9. A tangible, non-transitory, machine-readable medium storing instructions that, when executed by a data processing apparatus, cause the data processing apparatus to perform operations comprising those of any of embodiments 1-8.

10. A system comprising: one or more processors; and memory storing instructions that, when executed by the processors, cause the processors to effectuate operations comprising those of any of embodiments 1-8.

11. A system comprising means for performing any of embodiments 1-8.

12. A system comprising cloud-based circuitry for performing any of embodiments 1-8.

Although the present invention has been described in detail for the purpose of illustration based on what is currently considered to be the most practical and preferred embodiments, it is to be understood that such detail is solely for that purpose, and that the invention is not limited to the disclosed embodiments, but on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

What is claimed is:

1. A system for running playbooks based on cluster drift, the system comprising:
one or more processors; and
a non-transitory computer-readable storage medium storing instructions, which when executed by the one or more processors cause the one or more processors to:
retrieve, from a first data source, user profile data for a plurality of users, wherein the user profile data comprises a first plurality of features;
retrieve from a second data source, user activity data for the plurality of users, wherein the user activity data comprises a second plurality of features;
transform the first plurality of features and the second plurality of features into a user dataset;
generate a plurality of vectors for the plurality of users within the user dataset;
input, into a machine learning model, the plurality of vectors to obtain a plurality of actions associated with the plurality of users;
generate a plurality of action clusters for the plurality of actions, wherein each action cluster of the plurality of action clusters comprises a set of users with a corresponding predicted action;
based on a corresponding action of the plurality of actions, identify, for each action cluster in the plurality of action clusters, a corresponding playbook to execute for users associated with a corresponding action cluster; and
execute the corresponding playbook for each action cluster of the plurality of action clusters.

2. The system of claim 1, wherein the instructions further cause the one or more processors to:
retrieve user profile training data comprising a first plurality of training features and user activity training data comprising a second plurality of training features, wherein the user profile training data and the user activity training data is associated with a training set of users;
retrieve action data comprising a plurality of training actions associated with the training set of users;
transform, into a training dataset, (1) the user profile training data, (2) the user activity training data, and (3) the action data, wherein the training dataset comprises (1) a subset of the first plurality of training features and the second plurality of training features and (2) the action data representing a corresponding label for each user identifying an observed action for each user;
transform the training dataset into a plurality of training vectors, wherein each vector of the plurality of vectors represents a user within a set of training users and each vector is associated with the corresponding label; and
train the machine learning model, using the plurality of training vectors to predict the corresponding action for each user in the set of training users.

3. The system of claim 1, wherein the instructions further cause the one or more processors to:
select a first action cluster of the plurality of action clusters;
determine a number of users within the first action cluster; and
based on the number of users within the first action cluster not meeting a threshold, remove the first action cluster from the plurality of action clusters.

4. The system of claim 1, wherein the instructions further cause the one or more processors to:
select a first action cluster of the plurality of action clusters;
determine one or more characteristics common to a first set of users within the first action cluster; and
pass one or more indicators of the one or more characteristics to a first playbook being executed for the first action cluster.

5. The system of claim 4, wherein the instructions further cause the one or more processors to execute the first playbook by:
generating a textual file for publication, wherein the textual file comprises the one or more characteristics marked as required and other characteristics of users within the first action cluster marked as optional.

6. The system of claim 4, wherein the instructions further cause the one or more processors to:
select a second action cluster of the plurality of action clusters;
determine that a type of action associated with the second action cluster indicates executing a second playbook for each user within the second action cluster, wherein the second playbook comprises one or more instructions to schedule a training class for each user; and
retrieve a plurality of electronic addresses for the users within the second action cluster for scheduling the training class.

7. The system of claim 6, wherein the instructions further cause the one or more processors to:
receive, from the machine learning model, output data indicating one or more features that caused the machine learning model to add the users into the second action cluster; and
determine, based on the one or more features, a training class type for the users in the second action cluster.

8. The system of claim 1, wherein the instructions further cause the one or more processors to:
select a first action cluster of the plurality of action clusters;
determine that a number of common characteristics for a first set of users within the first action cluster does not meet a threshold; and
based on determining that the number of common characteristics for the set of users within the first action cluster does not meet the threshold, remove the first action cluster from the plurality of action clusters.

9. A method for running playbooks based on cluster drift, the method comprising:
receiving user profile data and user activity data for a plurality of users, wherein the user profile data comprises a first plurality of features, and wherein the user activity data comprises a second plurality of features;
transforming the first plurality of features and the second plurality of features into a user dataset;
generating a plurality of vectors for the plurality of users within the user dataset;
inputting, into a machine learning model, the plurality of vectors to obtain a plurality of actions associated with the plurality of users;
generating a plurality of action clusters for the plurality of actions, wherein each action cluster of the plurality of action clusters comprises a set of users with a corresponding predicted action;
based on a corresponding action of the plurality of actions, identifying, for each action cluster in the plurality of action clusters, a corresponding action sequence to execute for users associated with a corresponding action cluster; and
executing the corresponding action sequence for each action cluster of the plurality of action clusters.

10. The method of claim 9, further comprising:
retrieving user profile training data comprising a first plurality of training features and user activity training data comprising a second plurality of training features, wherein the user profile training data and the user activity training data is associated with a training set of users;
retrieving action data comprising a plurality of training actions associated with the training set of users;
transforming, into a training dataset, (1) the user profile training data, (2) the user activity training data, and (3) the action data, wherein the training dataset comprises (1) a subset of the first plurality of training features and the second plurality of training features and (2) the action data representing a corresponding label for each user identifying an observed action for each user;
transforming the training dataset into a plurality of training vectors, wherein each vector of the plurality of vectors represents a user within a set of training users and each vector is associated with the corresponding label; and
training the machine learning model, using the plurality of training vectors to predict the corresponding action for each user in the set of training users.

11. The method of claim 9, further comprising:
selecting a first action cluster of the plurality of action clusters;
determining a number of users within the first action cluster; and
based on the number of users within the first action cluster not meeting a threshold, removing the first action cluster from the plurality of action clusters.

12. The method of claim 9, further comprising:
selecting a first action cluster of the plurality of action clusters;
determining one or more characteristics common to a first set of users within the first action cluster; and
passing one or more indicators of the one or more characteristics to a first action sequence being executed for the first action cluster.

13. The method of claim 12, further comprising executing the first action sequence by generating a textual file for publication, wherein the textual file comprises the one or more characteristics marked as required and other characteristics of users within the first action cluster marked as optional.

14. The method of claim 12, further comprising:
selecting a second action cluster of the plurality of action clusters;
determining that a type of action associated with the second action cluster indicates executing a second playbook for each user within the second action cluster, wherein the second playbook comprises one or more instructions to schedule a training class for each user; and
retrieving a plurality of electronic addresses for the users within the second action cluster for scheduling the training class.

15. The method of claim 14, further comprising:
receiving, from the machine learning model, output data indicating one or more features that caused the machine learning model to add the users into the second action cluster; and
determining, based on the one or more features, a training class type for the users in the second action cluster.

16. The method of claim 9, further comprising:
selecting a first action cluster of the plurality of action clusters;
determining that a number of common characteristics for a first set of users within the first action cluster does not meet a threshold; and
based on determining that the number of common characteristics for the set of users within the first action cluster does not meet the threshold, removing the first action cluster from the plurality of action clusters.

17. A non-transitory, computer-readable medium storing instructions thereon, wherein the instructions cause one or more processors to:
receive user data for a plurality of users, wherein the user data comprises a plurality of fields;
transform the user data into a user dataset comprising a plurality of features;
generate a plurality of vectors for the plurality of users within the user dataset;
input, into a machine learning model, the plurality of vectors to obtain a plurality of actions associated with the plurality of users;
generate a plurality of action clusters for the plurality of actions, wherein each action cluster of the plurality of action clusters comprises a set of users with a corresponding predicted action;
based on a corresponding action of the plurality of actions, identify, for each action cluster in the plurality of action clusters, a corresponding action sequence to execute for users associated with a corresponding action cluster; and
execute the corresponding action sequence for each action cluster of the plurality of action clusters.

18. The non-transitory, computer-readable medium of claim 17, wherein the instructions further cause the one or more processors to:
retrieve user profile training data comprising a first plurality of training features and user activity training data comprising a second plurality of training features, wherein the user profile training data and the user activity training data is associated with a training set of users;
retrieve action data comprising a plurality of training actions associated with the training set of users;
transform, into a training dataset, (1) the user profile training data, (2) the user activity training data, and (3) the action data, wherein the training dataset comprises (1) a subset of the first plurality of training features and the second plurality of training features and (2) the action data representing a corresponding label for each user identifying an observed action for each user;
transform the training dataset into a plurality of training vectors, wherein each vector of the plurality of vectors represents a user within a set of training users and each vector is associated with the corresponding label; and
train the machine learning model, using the plurality of training vectors to predict the corresponding action for each user in the set of training users.

19. The non-transitory, computer-readable medium of claim 17, wherein the instructions further cause the one or more processors to:
select a first action cluster of the plurality of action clusters;
determine a number of users within the first action cluster; and
based on the number of users within the first action cluster not meeting a threshold, remove the first action cluster from the plurality of action clusters.

20. The non-transitory, computer-readable medium of claim 17, wherein the instructions further cause the one or more processors to:
select a first action cluster of the plurality of action clusters;
determine one or more characteristics common to a first set of users within the first action cluster; and
pass one or more indicators of the one or more characteristics to a first action sequence being executed for the first action cluster.
